(19) United States
(12) Patent Application Publication
(10) Pub. No.: US 2013/0319486 A1
(43) Pub. Date: Dec. 5, 2013

(54) WASHER SYSTEM FOR VEHICLE

(71) Applicant: ASMO CO., LTD., Kosai-city (JP)

(72) Inventors: Tomoyuki KIKUTA, Toyohashi-city (JP); Yukihiro MATSUSHITA, Hamamatsu-city (JP)

(73) Assignee: ASMO CO., LTD., Kosai-city (JP)

(21) Appl. No.: 13/773,956

(22) Filed: Feb. 22, 2013

(30) Foreign Application Priority Data
May 31, 2012 (JP) 2012-124462
May 31, 2012 (JP) 2012-124520

(51) Int. Cl. B60S 1/66

(52) U.S. Cl. CPC B60S 1/66
USPC 134/123

(57) ABSTRACT

An electric pump pumps washer fluid out of a tank installed in a vehicle. A rear camera washer nozzle discharges the washer fluid to a lens side of a rear camera installed to a back door of the vehicle upon receiving the washer fluid from the electric pump. A control circuit unit limits discharging of the washer fluid from the rear camera washer nozzle when the back door is in an open state. The tank may be installed in a luggage room located at a rear side of the vehicle.

### CROSS REFERENCE TO RELATED APPLICATION

This application is based on and incorporates herein by reference Japanese Patent Application No. 2012-124520 filed on May 31, 2012 and Japanese Patent Application No. 2012-124462 filed on May 31, 2012.

### TECHNICAL FIELD

The present disclosure relates to a washer system for a vehicle.

### BACKGROUND

Lately, some vehicles have a rear camera. The rear camera is installed to a back door of the vehicle or another portion of a body of the vehicle, which is adjacent to the back door (e.g., a portion of the body of the vehicle located on an upper side of the back door). An image, which is captured through the rear camera, is displayed on a monitor device of a vehicle navigation system to enable a driver of the vehicle to visually check the rear side of the vehicle. Furthermore, in some cases, a rear camera washer nozzle is installed to the vehicle to spray washer fluid to the rear camera (more specifically, a lens side of the rear camera where a lens of the rear camera is located) and thereby to wash the rear camera. JP2011-244417A (corresponding to US2011/0073142A1) and JP2011-245989A (corresponding to US2011/0292212A1) teach such a washer system. In such a washer system, when the driver of the vehicle turns on a corresponding washer switch, an electric pump (an electric motor of the electric pump) is driven to pump the washer fluid stored in a tank to the rear camera washer nozzle. Thereby, the washer fluid is discharged, i.e., sprayed from the rear camera washer nozzle to the rear camera (the lens side of the rear camera) to wash the same.

However, in the washer system discussed above, when the washer switch is turned on in a state where the back door is in an open state, the washer fluid, which is sprayed from the rear camera washer nozzle, may possibly enter an interior compartment (an inside of the back door) of the vehicle through an opening between the back door and the adjacent part of the body of the vehicle, which is adjacent to the back door.

Furthermore, in the washer system of JP2011-244417A (corresponding to US2011/0073142A1) and JP2011-245989A (corresponding to US2011/0292212A1), the tank is installed in an engine room at a front side of the vehicle and stores the washer fluid.

For instance, in a cold winter, particularly, at a cold weather region, a heat is taken from the washer fluid at the time of flowing from the tank (the electric pump) at the front side of the vehicle (the engine room) to the rear camera washer nozzle at the rear side of the vehicle through a conduit. Thereby, the temperature of the washer fluid is decreased. When the temperature of the washer fluid is decreased, a viscosity of the washer fluid is increased. In the case of the washer system for washing the rear camera, the washer fluid is merely sprayed to the lens side of the rear camera to wash the lens side of the rear camera without using the wiper. Therefore, when the viscosity of the washer fluid is increased, the washer fluid does not effectively flow out of the lens side of the rear camera to cause presence of residue droplets of the washer fluid at the lens side of the rear camera. The residue droplets of the washer fluid may possibly cause a distortion of the captured image (the rear view).

### SUMMARY

The present disclosure addresses the above disadvantages. According to the present disclosure, there is provided a washer system for a vehicle, including a tank, an electric pump, a nozzle and a discharge limiting device. The tank stores washer fluid. The electric pump pumps the washer fluid out of the tank. The nozzle discharges the washer fluid to a washing subject installed in the vehicle upon receiving the washer fluid from the electric pump. The washing subject is installed to an openable and closable body of the vehicle or an adjacent portion of a body of the vehicle, which is adjacent to the openable and closable body. The discharge limiting device limits discharging of the washer fluid from the nozzle when the openable and closable body is in an open state.

According to the present disclosure, there is also provided a washer system for a vehicle, including a tank, an electric pump, a rear camera washer nozzle and at least one conduit. The tank stores washer fluid and is installed in a luggage room of the vehicle. The electric pump pumps the washer fluid out of the tank. The rear camera washer nozzle discharges the washer fluid to a lens side of a rear camera upon receiving the washer fluid from the electric pump. The rear camera is installed to a rear side of the vehicle. The at least one conduit connects between the electric pump and the rear camera washer nozzle.

### BRIEF DESCRIPTION OF THE DRAWINGS

The drawings described herein are for illustration purposes only and are not intended to limit the scope of the present disclosure in any way.

FIG. 1A is a schematic diagram of a vehicle having a washer system according to a first embodiment of the present disclosure;

FIG. 1B is a circuit diagram showing an electrical construction of the washer system of the first embodiment;

FIG. 2 is a schematic diagram showing a washer system according to a second embodiment of the present disclosure;

FIG. 3A is a schematic diagram showing a washer system according to a third embodiment of the present disclosure;

FIG. 3B is a circuit diagram showing an electrical construction of the washer system of the third embodiment;

FIG. 4 is a schematic diagram showing a modification of the washer system of the third embodiment;

FIG. 5A is a schematic diagram showing a washer system according to a fourth embodiment of the present disclosure;

FIG. 5B is a circuit diagram showing an electrical construction of the washer system of the fourth embodiment;

FIG. 6A is a schematic diagram showing a tank and an electric pump of the washer system according to the fourth embodiment, indicating an installed state of the tank relative to a tank receiving portion of a housing;

FIG. 6B is a schematic diagram showing the tank and the electric pump of the washer system of FIG. 6A, indicating an uninstalled state (detached state) of the tank relative to the tank receiving portion of the housing;

FIG. 7A is a schematic diagram showing a washer system according to a fifth embodiment of the present disclosure; and

FIG. 7B is a circuit diagram showing an electrical construction of the washer system of the fifth embodiment shown in FIG. 7A.

### DETAILED DESCRIPTION

### First Embodiment

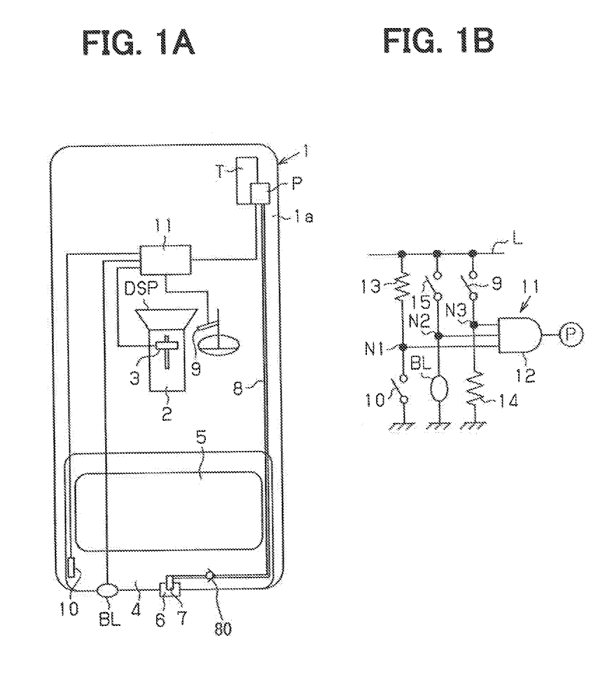

A washer system of a vehicle (e.g., an automobile) according to a first embodiment of the present disclosure will be described with reference to FIGS. 1A and 1B.

As shown in FIG. 1A, a shift lever 3 of a transmission 2 is placed on a lateral side of a driver's seat in an interior compartment (passenger compartment) of the vehicle 1. In the present embodiment, the vehicle 1 is, for example, a minivan (or a van). However, the type of the vehicle 1 is not limited to the minivan and may be changed to any other suitable type of vehicle, such as a hatchback. When the shift lever 3 is manipulated by a driver (user) of the vehicle, a gear ratio of the transmission 2 is changed to change a speed of the vehicle 1. For instance, when the shift lever 3 is placed in a first speed position, the gear ratio of the transmission 2 is sifted to a first speed gear ratio. When the shift lever 3 is placed in a second speed position, the gear ratio of the transmission 2 is sifted to a second speed gear ratio. Furthermore, when the shift lever 3 is placed in a neutral position, the transmission 2 is sifted into a neutral state.

When the shift lever 3 is placed in a reverse position, the vehicle 1 is enabled to move backward (placing the vehicle 1 into a backwardly movable state, i.e., a reverse drive mode). At this time, a back lamp BL, which is provided at a rear side of the vehicle 1, is turned on, i.e., is lit as long as the shift lever 3 is placed in the reverse position.

Furthermore, a display device DSP is placed at a console panel of the vehicle 1. The display device DSP is used in a car navigation system to display a current location of the vehicle and a map. A back door (rear door) 4 is provided at a rear side of the vehicle 1. The back door 4 serves as an openable and closable body, which is openable and closable relative to the rest of a body (a vehicle body) 1a of the vehicle 1.

A rear window glass 5 is installed at a middle to upper portion of the back door 4. Furthermore, a rear camera 6 is installed at a lower portion of the back door 4, which is located on a lower side of the rear window glass 5. The rear camera 6 is also referred to as a rear view camera and is used to monitor a rear view of the vehicle. An image, which is captured through the rear camera 6, is outputted to the display device DSP. The display device DSP displays the image, which is captured by the rear camera 6, on a screen of the display device DSP based on image data of the captured image.

When the shift lever 3 of the transmission 2 is placed into the reverse position to place the vehicle in the reverse drive mode, the rear camera 6 begins to capture the image and outputs the image data of the captured image to the display device DSP. Then, when the shift lever 3 is shifted from the reverse position to another position (a non-reverse position), which is other than the reverse position, the rear camera 6 terminates the capturing of the image.

A rear camera washer nozzle 7 is installed to the back door 4 at a location, which is adjacent to the rear camera 6 and is outside of a viewing range (image capturing range) of the rear camera 6. A washer fluid discharge opening of the rear camera washer nozzle 7 is directed to the rear camera 6 (more specifically, a lens side of the rear camera 6 where a lens of the rear camera 6 is located) to discharge, i.e., spray washer fluid to the rear camera 6 through the washer fluid discharge opening of the rear camera washer nozzle 7. Here, it should be noted that a surface of the lens side of the rear camera 6, which is washed with the washer fluid, may be a surface of a cover placed in front of the lens or a surface of the lens itself in a case where the lens is directly exposed to the outside. Furthermore, in the present embodiment, the rear camera 6 serves as a washing subject.

The rear camera washer nozzle 7 is connected to an electric pump P, which is installed in an engine room of the vehicle 1 at a front side of the vehicle 1, through a conduit 8. Specifically, the electric pump P has a pump motor (not shown) and feeds the washer fluid, which is stored in a tank T installed in the engine room, to the rear camera washer nozzle 7 through the conduit 8. Furthermore, a check valve 80 is installed in the conduit 8 at a location adjacent to the rear camera washer nozzle 7 on the upstream side of the rear camera washer nozzle 7. In FIG. 1A, the check valve 80 is provided separately from the rear camera washer nozzle 7. Alternatively, the check valve 80 and the rear camera washer nozzle 7 may be formed integrally such that the check valve 80 is located on the upstream side of the rear camera washer nozzle 7. The check valve 80 disables flow of the washer fluid (and air) from a downstream side (rear camera washer nozzle 7 side) of the check valve 80 to an upstream side (electric pump P side) of the check valve 80 through the check valve 80. In contrast, the check valve 80 enables flow of the washer fluid from the upstream side of the check valve 80 to the downstream side of the check valve 80 through the check valve 80. With the check valve 80, it is possible to hold the washer fluid in the interior space of the conduit 8 between the electric pump P and the check valve 80 by limiting the flow of the air from the rear camera washer nozzle 7 toward the electric pump P through the check valve 80. Thus, intrusion of the air into the interior of the conduit 8 through the rear camera washer nozzle 7 can be limited. When the air is mixed into the washer fluid, the washer fluid, which is sprayed from the rear camera washer nozzle 7 onto the lens side of the rear camera 6, may possibly form washer fluid bubbles on the lens side of the rear camera 6. The washer fluid bubbles will interfere with the capturing of the clear view through the rear camera 6. However, the provision of the check valve 80 can advantageously limit the intrusion of the air into the interior of the conduit 8 to limit the formation of the washer fluid bubbles on the lens side of the rear camera 6.

A washer switch 9 is installed to a washer manipulation lever (wiper control lever) that is placed at a corresponding location, which is adjacent to the driver's seat, and a driver of the vehicle manipulates the washer switch 9 to turn on, i.e., to drive the electric pump P.

Furthermore, a back door opening/closing sensing switch 10 is installed in the vehicle. The back door opening/closing sensing switch 10 can sense whether the back door 4 is opened, i.e., is in an open state. The open state of the back door 4 includes a full open state of the back door 4 and a semi-open state of the back door 4. The semi-open state of the back door 4 may be a half-locked state or a half-latched state of the back door 4.

Also, a control circuit unit 11 is installed in the vehicle. The control circuit unit 11 serves as a discharge limiting device (also referred to as a discharge limiting means) and a washing control device, which determine whether the electric pump P needs to be driven.

The control circuit unit 11 drives the electric pump P upon satisfaction of all of the following three conditions (prerequisite conditions), i.e., the shift lever 3 being in the reverse position (the position for placing the vehicle 1 into the backwardly movable state, i.e., the reverse drive mode), the back door 4 being in a closed state, and the washer switch 9 being turned on (i.e., being in an ON state).

Specifically, as shown in FIG. 1B, the control circuit unit 11 includes an AND circuit 12, a resistor 13 and a resistor 14. The resistor 13 and the back door opening/closing sensing switch 10 are connected one after another in series between a power source line L and a ground (earth). The back door opening/closing sensing switch 10 is turned on when the back door 4 is in the closed state. Furthermore, a reverse drive sensing switch 15 and the back lamp BL are connected one after another in series between the power source line L and the ground. The reverse drive sensing switch 15 is turned on when the shift lever 3 is placed in the reverse position. The washer switch 9 and the resistor 14 are connected one after another in series between the power source line L and the ground.

Furthermore, three nodes, i.e., a node N1, a node N2 and a node N3 are connected to three input terminals, respectively, of the AND circuit 12. The node N1 is placed between the resistor 13 and the back door opening/closing sensing switch 10. The node N2 is placed between the reverse drive sensing switch 15 and the back lamp BL. The node N3 is placed between the washer switch 9 and the resistor 14. An output terminal of the AND circuit 12 is connected to the electric pump P (the pump motor), which is driven in response to an H-level (high level) signal outputted from the output terminal of the AND circuit 12.

Next, an operation of the washer system of the present embodiment, which is constructed in the above described manner, will be described. For instance, when the shift lever 3 is in the other position (the non-reverse position), which is other than the reverse position, the reverse drive sensing switch 15 is turned off (i.e., placed in an OFF state). Therefore, the back lamp BL is turned off. In this state, an L-level (low level) signal is inputted from the node N2 to the AND circuit 12. Therefore, the H-level signal is not outputted from the AND circuit 12. As a result, the electric pump P (the pump motor) is held in the stop state.

For instance, when the shift lever 3 is in the reverse position, the reverse drive sensing switch 15 is turned on (i.e., placed in an ON state). Therefore, the back lamp BL is turned on. In this state, when the back door 4 is in the closed state, the back door opening/closing sensing switch 10 is turned on (i.e., placed in an ON state). Therefore, in such a case, when the washer switch 9 is turned on by the driver, the electric pump P (the pump motor) is driven. That is, the H-level signal is supplied from all of the nodes N1, N2, N3 to the AND circuit 12 when the washer switch 9 is turned on in the state where the reverse drive sensing switch 15 is turned on, and the back door opening/closing sensing switch 10 is turned on. Therefore, the H-level signal is outputted from the AND circuit 12, and thereby the electric pump P (the pump motor) is driven. Thus, the washer fluid, which is stored in the tank T, is pumped out of the tank T to the rear camera washer nozzle 7 through the conduit 8 and is discharged, i.e., is sprayed to the lens side of the rear camera 6 from the washer fluid discharge opening of the rear camera washer nozzle 7. In this way, the rear camera 6 is washed. At this time, since the back door 4 is in the closed state, intrusion of the washer fluid into the interior compartment (inside of the back door 4) of the vehicle is limited.

Furthermore, the H-level signal is not outputted from the AND circuit 12 even when the washer switch 9 is turned on in the state where the back door opening/closing sensing switch 10 is turned off, and the reverse drive sensing switch 15 is turned on. Therefore, in such a case, the electric pump P (the pump motor) is held in the stop state. That is, when the back door 4 is in the open state, the spraying of the washer fluid from the rear camera washer nozzle 7 is limited, i.e., is stopped.

Next, advantages of the present embodiment will be described.

(1) In the open state of the back door 4, the control circuit unit 11 (the discharge limiting device, which is also referred to as the discharge limiting means) limits the discharging, i.e., the spraying of the washer fluid from the rear camera washer nozzle 7, which is configured to discharge, i.e., spray the washer fluid to the lens side of the rear camera 6 installed to the back door 4. Therefore, it is possible to limit the intrusion of the washer fluid into the interior compartment (the inside of the back door 4).

(2) In the open state of the back door 4, the control circuit unit 11 places the electric pump P in the stop state. Therefore, the spraying of the washer fluid from the rear camera washer nozzle 7 is limited (prevented). In this way, the spraying of the washer fluid can be limited (prevented) with the simple structure. Specifically, for instance, in a case where a valve drive device, which serves as a discharge limiting device (a discharge limiting means), is provided to enable and disable communication of the fluid passage between the electric pump P and the washer fluid discharge opening of the rear camera washer nozzle 7, a size of the washer system may be disadvantageously increased by the valve drive device, and an electric power may be wasted to drive the electric pump P. Also, in such a case, a pressure of the flow passage may be increased, and thereby a countermeasure may be required to counteract with the pressure increase. In contrast, according to the present embodiment, the above disadvantages can be limited, and the spraying of the washer fluid can be appropriately limited (prevented) with the simple structure.

In the above embodiment, the single washing subject (the lens side of the rear camera 6) and the single nozzle (the rear camera washer nozzle 7) are provided, and this single nozzle (the rear camera washer nozzle 7) is configured to spray the washer fluid to the washing subject. Alternatively, the washer system may have a plurality of nozzles to enable spraying of the washer fluid from each corresponding one of the nozzles to a corresponding one of a plurality of washing subjects in the vehicle.

### Second Embodiment

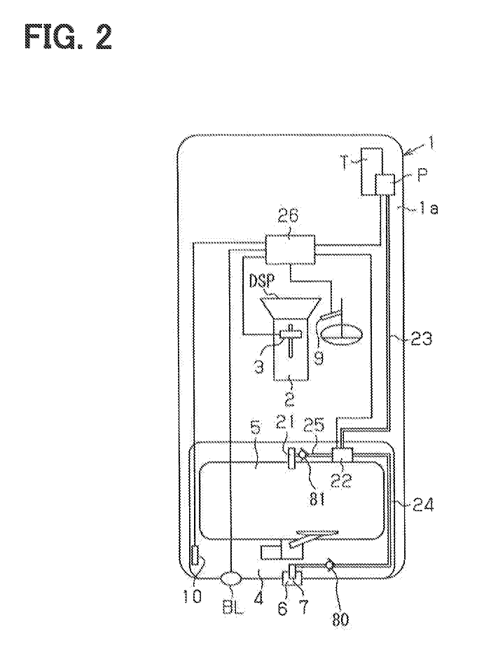

Now, a second embodiment of the present disclosure will be described with reference to FIG. 2. In the second embodiment as well as the subsequent embodiments, components, which are similar to those of the first embodiment, will be indicated by the same reference numerals and will not be discussed redundantly for the sake of simplicity.

The second embodiment is a modification of the first embodiment. In contrast to the first embodiment discussed with reference to FIGS. 1A and 1B, in the washer system of the second embodiment shown in FIG. 2, a rear window glass washer nozzle 21 is installed to an upper portion of the vehicle body 1a, which is located above the rear window glass 5. The rear window glass washer nozzle 21 is added to spray the washer fluid to the rear window glass 5, which serves as a washing subject and is provided at the back door 4 (the openable and closable body). Furthermore, in the second embodiment, a switching valve device 22, which serves as a switching device (also referred to as a switching means), is installed in the vehicle. The switching valve device 22 is provided to selectively supply the washer fluid from the electric pump P to a corresponding one of the nozzles (the rear camera washer nozzle 7 and the rear window glass washer nozzle 21). Specifically, the electric pump P is connected to the switching valve device 22 through a conduit 23. In turn, the switching valve device 22 is connected to the rear camera washer nozzle 7 and the rear window glass washer nozzle 21 through a conduit 24 and a conduit 25, respectively. Like in the first embodiment discussed with reference to FIGS. 1A and 1B, the check valve 80 is installed in the conduit 24 at a location adjacent to the rear camera washer nozzle 7. Furthermore, a check valve 81 is installed in the conduit 25 at a location adjacent to the rear window glass washer nozzle 21 to have a function similar to that of the check valve 80. The switching valve device 22 selectively supplies the washer fluid from the electric pump P to the corresponding one of the rear camera washer nozzle 7 and the rear window glass washer nozzle 21 based on a switching control signal received from a control circuit unit 26. The control circuit unit 26 of the second embodiment (see FIG. 2) drives the electric pump P after switching the switching valve device 22 to the rear camera washer nozzle 7 side upon satisfaction of all of the following three conditions, i.e., the shift lever 3 being in the reverse position, the back door 4 being in the closed state, and the washer switch 9 being in the ON state. Thus, the washer fluid is supplied to the rear camera washer nozzle 7. Alternatively, the control circuit unit 26 of the second embodiment (see FIG. 2) drives the electric pump P after switching the switching valve device 22 to the rear window glass washer nozzle 21 side upon satisfaction of all of the following three conditions, i.e., the shift lever 3 being in the other position (the non-reverse position), which is other than the reverse position, the back door 4 being in the closed state, and the washer switch 9 being in the ON state. Thus, the washer fluid is supplied to the rear window glass washer nozzle 21. The control circuit unit 26 limits (stops) the spraying of the washer fluid from both of the rear camera washer nozzle 7 and the rear window glass washer nozzle 21 by stopping the electric pump P when the back door 4 is in the open state regardless of the operational position of the shift lever 3 and the operational state of the washer switch 9.

Even in this way, the intrusion of the washer fluid into the interior compartment (the inside of the back door 4) can be limited. Furthermore, the washer system of the second embodiment includes the switching valve device 22, which selectively supplies the washer fluid from the electric pump P to the corresponding one of the nozzles (the rear camera washer nozzle 7 and the rear window glass washer nozzle 21). Therefore, the washer fluid is not sprayed to the unintended one of the washing subjects (the one of the rear camera 6 and the rear window glass 5), which is other than the intended one of the washing subjects (the other one of the rear camera 6 and the rear window glass 5). Thus, for example, the wasteful consumption of the washer fluid can be limited.

Furthermore, in the second embodiment, the switching valve device 22 is used as the switching device (switching means), which selectively supplies the washer fluid from the electric pump P to the corresponding one of the nozzles. However, the present disclosure is not limited to this. For instance, the electric pump P may be modified to an electric pump that has a double outlet mechanism (serving as a switching device also referred to as a switching means), which can selectively supply the washer fluid to a corresponding one of the nozzles by changing a rotational direction of the pump motor.

### Third Embodiment

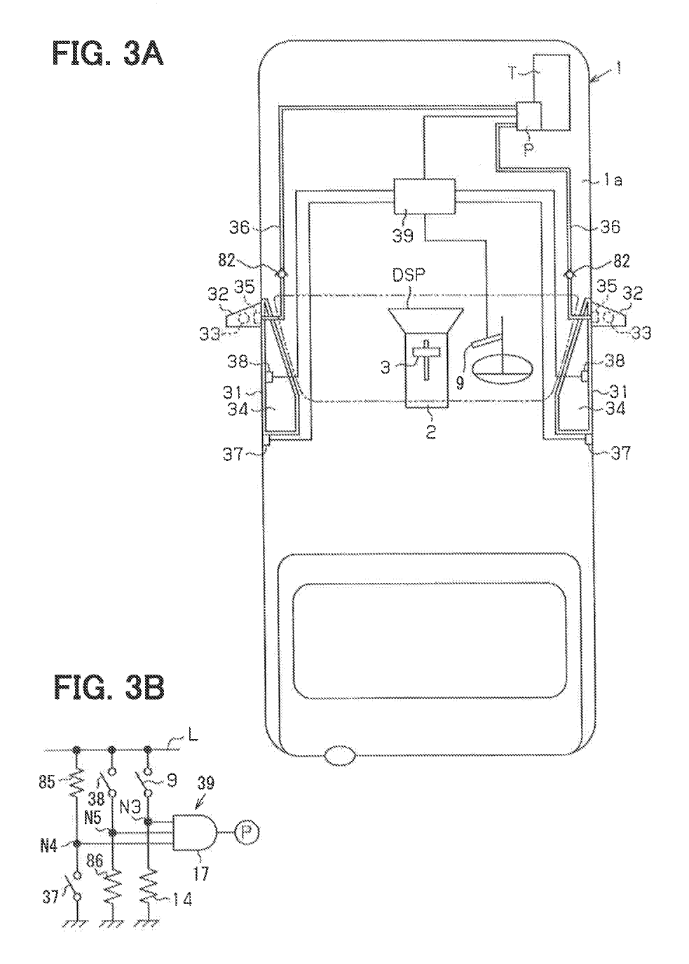

Now, a third embodiment of the present disclosure will be described with reference to FIGS. 3A and 3B.

In the first and second embodiments, the present disclosure is implemented in the vehicle, which has the back door 4 as the openable and closable body, and the operational state of the back door 4 (the openable and closable body) serves as the one of the conditions for determining whether the spraying of the washer fluid needs to be limited (stopped). However, the present disclosure is not limited to this. For instance, an operational state of one or more different openable and closable bodies (or one or more different devices placed adjacent to the one or more different operable and closable bodies) may serve as one or more of conditions for determining whether the spraying of the washer fluid needs to be limited (stopped).

Specifically, in the third embodiment, as shown in FIG. 3A, a door mirror 32 is installed to each side door (front door) 31, which serves as an openable and closable body. A side camera 33 is installed to a lower surface of the door mirror 32. The side camera 33 captures an image of a blind spot at a lateral side of the vehicle body. In the third embodiment, the side camera 33 (more specifically, a lens side of the side camera 33 where a lens of the side camera 33 is located) serves as a washing subject. An operational state of the side door 31 and an operational state of a side window glass (door window glass) 34 installed to the side door 31 serve as two of conditions for determining whether the spraying of the washer fluid needs to be limited, i.e., stopped.

A side camera washer nozzle 35 is installed to the door mirror 32. The side camera washer nozzle 35 discharges, i.e., sprays the washer fluid to the side camera 33 (more specifically, the lens side of the side camera 33 where the lens of the side camera 33 is located). The side camera washer nozzle 35 is connected to the electric pump P through a conduit 36. Furthermore, a side door opening/closing sensing switch 37 is installed in the vehicle. The side door opening/closing sensing switch 37 can sense whether the side door 31 is in an open state. Furthermore, a side window glass opening/closing sensing switch 38 is provided in the vehicle (the side door 31). The side window glass opening/closing sensing switch 38 can sense whether the side window glass 34 is in an open state. In the third embodiment, a door courtesy switch may be used as the side door opening/closing sensing switch 37, and a sensor of a power window motor may be used as the side window glass opening/closing sensing switch 38. Furthermore, the open state of each of the side door 31 and the side window glass 34 includes a full open state thereof as well as a semi-open state thereof.

Furthermore, a control circuit unit 39 of the third embodiment (see FIGS. 3A and 3B) drives the electric pump P based on signals outputted from the side door opening/closing sensing switch 37, the side window glass opening/closing sensing switch 38 and the washer switch 9 upon satisfaction of all of the following two conditions, i.e., the side door 31 and the side window glass 34 being in the closed state, and the washer switch 9 being in the ON state. Furthermore, the control circuit unit 39 of the present embodiment limits (stops) the spraying of the washer fluid from the side camera washer nozzle 35 by stopping the electric pump P when at least one of the side door 31 and the side window glass 34 is in an open state regardless of the state of the washer switch 9.

Specifically, as shown in FIG. 3B, the control circuit unit 39 includes an AND circuit 17, a resistor 85, a resistor 86 and the resistor 14. The resistor 85 and the side door opening/closing sensing switch 37 are connected one after another in series between the power source line L and the ground (earth). The side door opening/closing sensing switch 37 is turned on when the side door 31 is in the closed state. Furthermore, the side window glass opening/closing sensing switch 38 and the resistor 86 are connected one after another in series between the power source line L and the ground. The side window glass opening/closing sensing switch 38 is turned on when the side window glass 34 is in the closed state. The washer switch 9 and the resistor 14 are connected one after another in series between the power source line L and the ground like in the first embodiment.

Furthermore, three nodes, i.e., a node N4, a node N5 and the node N3 are connected to three input terminals, respectively, of the AND circuit 17. The node N4 is placed between the resistor 85 and the side door opening/closing sensing switch 37. The node N5 is placed between the side window glass opening/closing sensing switch 38 and the resistor 86. The node N3 is placed between the washer switch 9 and the resistor 14. Similar to the first embodiment, an output terminal of the AND circuit 17 is connected to the electric pump P (the pump motor), which is driven in response to an H-level signal outputted from the output terminal of the AND circuit 17.

Next, an operation of the washer system of the third embodiment, which is constructed in the above described manner, will be described. For instance, when the side door 31 is in the open state (the side door opening/closing sensing switch 37 being in the OFF state), an L-level signal is inputted from the node N4 to the AND circuit 17. Therefore, the H-level signal is not outputted from the AND circuit 17. As a result, the electric pump P (the pump motor) is held in the stop state. Also, when the side window glass 34 is in the open state (the side window glass opening/closing sensing switch 38 being in the OFF state), an L-level signal is inputted from the node N5 to the AND circuit 17. Therefore, the H-level signal is not outputted from the AND circuit 17. In contrast, when the side door 31 and the side window glass 34 are both closed, the H-level signal is outputted from each of the node N4 and the node N5 to the corresponding input terminals of the AND circuit 17. In this state, when the washer switch 9 is turned on, the H-level signal is outputted from the node N3 to the corresponding input terminal of the AND circuit 17. Therefore, the H-level signal is outputted from the AND circuit 17 to the electric pump P, and thereby the electric pump P (the pump motor) is driven. Thus, the washer fluid, which is stored in the tank T, is pumped to the side camera washer nozzle 35 through the conduit 36 and is discharged, i.e., is sprayed to the lens side of the side camera 33 from the washer fluid discharge opening of the side camera washer nozzle 35. In this way, each side camera 33 is washed. At this time, since the side door 31 and the side window glass 34 are both in the closed state, intrusion of the washer fluid into the interior compartment (inside of the side door 31 and the side window glass 34) of the vehicle is limited.

Here, it should be noted that the above discussion is made only for the side door 31 and the side window glass 34 located on one side (one of the left side and the right side) of the vehicle. However, the above embodiment may be applied to the side doors (front doors) 31 and the side window glasses 34 located on the left and right sides of the vehicle. Specifically, in FIG. 3B, the side door opening/closing sensing switch 37 on the left side of the vehicle and the side door opening/closing sensing switch 37 on the right side of the vehicle may be connected one after another in series between the node N4 and the ground. Also, the side window glass opening/closing sensing switch 38 on the left side of the vehicle and the side window glass opening/closing sensing switch 38 on the right side of the vehicle may be connected one after another in series between the node N5 and the power source line L. In this way, when any one of the side doors (front doors) 31 and the side window glasses 34 is in the open state, the H-level signal is not outputted from the AND circuit 17 to the electric pump P. Thus, the electric pump P is not driven. In contrast, when all of the side doors (front doors) 31 and the side window glasses 34 are in the closed state, the H-level signal is outputted from the AND circuit 17 to the electric pump P. Thus, the electric pump P is driven to pump the washer fluid to both of the side camera washer nozzles 35 located on the left side and the right side, respectively, of the vehicles to discharge, i.e., spray the washer fluid to the lens side of each of the side cameras 33.

Even in this way, the intrusion of the washer fluid into the interior compartment (the inside of the side door 31 and the side window glass 34) can be advantageously limited, as discussed above. In the present embodiment, the side door 31 and the side window glass 34 of the side door 31 serve as the openable and closable bodies, and the side camera 33. which serves as the washing subject, is installed to the side door 31. Alternatively, the side camera 33 may be installed to another portion of the vehicle body 1a, which is located adjacent to the side door 31, and the spraying of the washer fluid may be limited (stopped) in the manner similar to the one discussed above.

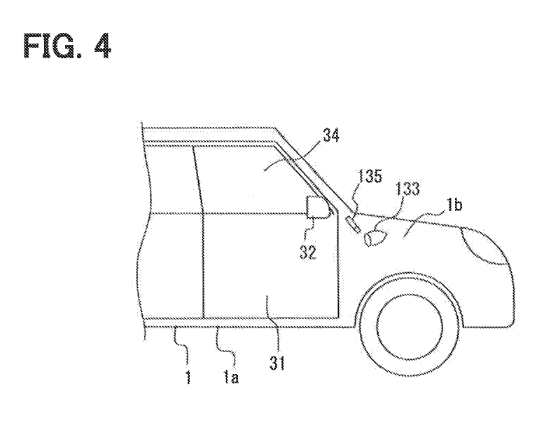

For instance, the third embodiment may be modified in a manner shown in FIG. 4. Specifically, a side camera 133 is installed to each of left and right fenders 1b of the vehicle body 1a to captures an image of a blind spot at the lateral side of the vehicle 1. Furthermore, a side camera washer nozzle 135 is installed to the fender 135 on the side of the side camera 133 where the side door 31 is located in the front-to-rear direction of the vehicle 1 on each of the left side and the right side of the vehicle 1. The side camera washer nozzles 135 are connected to the electric pump P, which is controlled by the control circuit unit 39 shown in FIGS. 3A and 3B. The operation of the washer system of this modification is similar to the operation of the washer system of the third embodiment shown in FIGS. 3A and 3B. That is, the operational state of the side door (front door) 31 and the operational state of the side window glass (door window glass) 34 serve as two of conditions for determining whether the spraying of the washer fluid needs to be limited, i.e., stopped. Thereby, when the side door 31 and the side window glass 34 are both in the closed state, the H-level signal is outputted from the AND circuit 17 to the electric pump P to pump the washer fluid to the side camera washer nozzles 135 to discharge, i.e., spray the washer fluid to the lens side of the side camera 133. Even in this way, the intrusion of the washer fluid, which is discharged from the side camera washer nozzle 135 and is splashed from the lens side of the side camera 133 upon application of the washer fluid to the lens side of the side camera 133, into the interior compartment (the inside of the side door 31 and the side window glass 34) can be advantageously limited, as discussed above.

Now, other modifications of the first to third embodiments will be described.

In the first embodiment (see FIGS. 1A and 113) as well as the second embodiment (see FIG. 2), the rear camera 6, which serves as the washing subject, is installed to the back door 4, which serves as the openable and closable body. Alternatively, the rear camera 6 may be installed to a portion of the vehicle body 1a, which is located adjacent to the back door 4, and the spraying of the washer fluid may be limited, i.e., stopped in a manner similar to the one discussed above. In the case where the sprayed washer fluid may possibly enter the inside of the openable and closable body in the open state of the openable and closable body, the openable and closable body and the corresponding nozzle (i.e., the nozzle that sprays the washer fluid) may be constructed in a manner similar to the ones discussed above (the spraying of the washer fluid being limited, i.e., stopped in the open state of the openable and closable body). Also, the present disclosure may be implemented in the vehicle having a plurality of openable and closable bodies and a plurality of nozzles. For instance, the first embodiment (see FIGS. 1A and 1B) and the third embodiment (see FIGS. 3A and 3B) may be combined together to implement such a construction.

In the first embodiment, when the back door 4 is in the open state, the control circuit unit 11 stops the electric pump P to stop the spraying of the washer fluid from the rear camera washer nozzle 7. Alternatively, the discharge limiting device (the control circuit unit 11), which is also referred to as the discharge limiting means and limits the spraying of the washer fluid from the nozzle (the rear camera washer nozzle 7), may be changed to any other suitable arrangement. For example, the valve drive device, which enables or disables the communication of the fluid passage (conduit) between the electric pump P and the washer fluid discharge opening of the rear camera washer nozzle 7, may be provided as the discharge limiting device (the discharge limiting means).

The circuit construction of the control circuit unit 11, 26, 39 is not limited to the one discussed in any one of the first to third embodiments. That is, the control circuit unit 11, 26, 39 may be modified to any other circuit structure that has similar functions, which are similar to the functions of the control circuit unit 11, 26, 39 of any of the first to third embodiments.

In the first embodiment, the placement of the shift lever 3 to the reverse position is the one of the conditions for driving the electric pump P. Alternatively, the condition(s) may be changed to any other suitable condition(s) as long as the spraying of the washer fluid is limited (stopped) in the state where the back door 4 is in the open state.

In the first embodiment, the tank T is installed in the engine room located at the front side of the vehicle 1, so that the tank T is used as a common tank that is also used for storing front window glass washer fluid. However, the present disclosure is not limited to this construction. For instance, the tank T may be installed at a rear side (e.g., a luggage room) of the vehicle 1.

In the above embodiments, the minivan is discussed as the example of the vehicle 1. Alternatively, the vehicle 1 may be a sedan automobile (also referred to as a saloon automobile). In such a case, a trunk door (trunk lid) may serve as an openable and closable body of the present disclosure like in a fourth embodiment discussed below.

### Fourth Embodiment

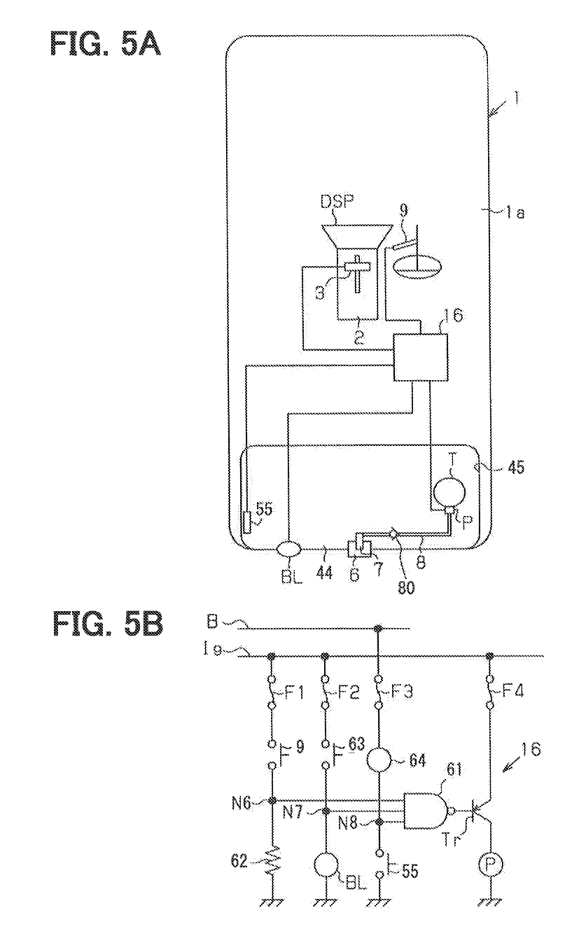

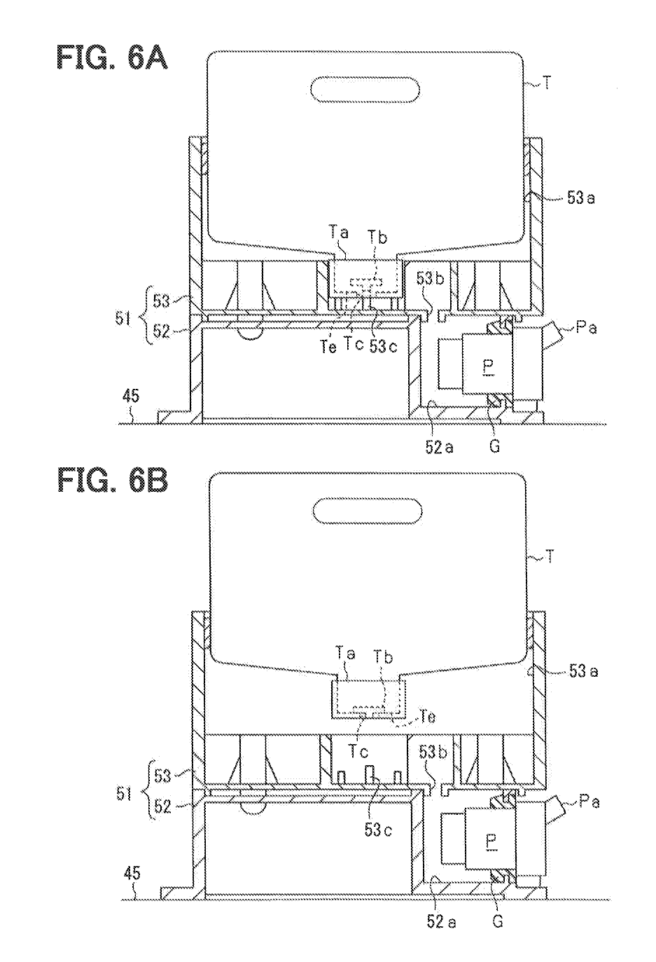

A washer system of a vehicle according to the fourth embodiment of the present disclosure will be described with reference to FIGS. 5A to 6B. With reference to FIG. 5A, the vehicle 1 is a sedan automobile (also referred to as a saloon automobile), and the shift lever 3 of the transmission 2 is placed on the lateral side of the driver's seat in the interior compartment of the vehicle. When the shift lever 3 is manipulated by the driver (user) of the vehicle, the gear ratio of the transmission 2 is changed to change the speed of the vehicle 1 like in the first embodiment.

A trunk door (trunk lid) 44 is provided at a rear side of the vehicle 1. The trunk door 44 is a back door (vehicle rear side door) that can be opened and closed relative to a rest of the body (vehicle body) 1a of the vehicle 1. A luggage room 45 is formed in an inside of the trunk door 44.

The rear camera 6, which is exposed to the outside of the vehicle 1, is installed to a rearmost part of the trunk door 44. The rear camera 6 is also referred to as a rear view camera and is used to monitor a rear view of the vehicle. An image, which is captured through the rear camera 6, is outputted to the display device DSP. The display device DSP displays the image, which is captured by the rear camera 6, on the screen of the display device DSP based on image data of the captured image.

When the shift lever 3 of the transmission 2 is placed in the reverse position to place the vehicle in the reverse drive mode, the rear camera 6 begins to capture the image and outputs the image data of the captured image to the display device DSP. Then, when the shift lever 3 is shifted from the reverse position to another position (the non-reverse position), which is other than the reverse position, the rear camera 6 terminates the capturing of the image.

The rear camera washer nozzle 7 is installed to the trunk door 44 at a location, which is adjacent to the rear camera 6 and is outside of a viewing range (image capturing range) of the rear camera 6. A washer fluid discharge opening of the rear camera washer nozzle 7 is directed to the rear camera 6 (more specifically, a lens side of the rear camera 6 where a lens of the rear camera 6 is located) to discharge, i.e., spray the pumped washer fluid to the rear camera 6 through the washer fluid discharge opening of the rear camera washer nozzle 7.

The rear camera washer nozzle 7 is connected to the electric pump P through a conduit 8. The electric pump P has a pump motor (not shown) and feeds the washer fluid, which is stored in the tank T, to the rear camera washer nozzle 7 through the conduit 8.

In the fourth embodiment, the tank T and the electric pump P are installed in the luggage room 45 (inside of the trunk door 44) at the rear side of the vehicle 1. In FIG. 5A, the tank T and the electric pump P. which are received in the luggage room 45, i.e., are received in the inside of the trunk door 44, are indicated with the solid lines without using a dotted line for the purpose of easy understanding.

As shown in FIG. 6A, the tank T and the electric pump P are installed to a housing 51 that is fixed to the luggage room 45. The housing 51 includes a lower housing 52 and an upper housing 53. The lower housing 52 is fixed to a wall of the luggage room 45. The upper housing 53 is fixed to an upper portion of the lower housing 52. A fluid reservoir 52a is formed in the lower housing 52. The electric pump P is fixed to a side of the fluid reservoir 52a through a water proof grommet (sealing grommet) G. The electric pump P is fixed such that a fluid suction port side (a middle to left side in FIG. 6A) of the electric pump P is received in the fluid reservoir 52a. A tank receiving portion 53a is formed in the upper housing 53. The tank receiving portion 53a has an opening (installation opening) at an upper side of the tank receiving portion 53a. The tank T is detachably installed in the tank receiving portion 53a through the opening of the tank receiving portion 53a, as shown in FIG. 6A that indicates an installed state of the tank T, which is inverted in the housing 51. A communication port 53b is formed in a bottom portion of the upper housing 53 and is communicated with the fluid reservoir 52a of the lower housing 52.

The tank T has a cap Ta that is installed to an opening Te of the tank T, which is located at a lower end of the tank T in the inverted state of the tank T shown in FIG. 6A. A fluid leakage limiting valve Tb is provided in the cap Ta. As shown in FIG. 6B, in an uninstalled state (detached state) where the tank T is not fully installed in the tank receiving portion 53a (a state where the tank T is not inserted to a lower end of the tank receiving portion 53a), the fluid leakage limiting valve Tb closes an outlet port (opening) Tc of the cap Ta, which is located at a lower side of the cap Ta, with an urging force of a spring (not shown). Thereby, leakage of the washer fluid from the tank T in a lifted state of the tank T is limited. Furthermore, in the installed state of that tank T shown in FIG. 6A where the tank T is installed to the tank receiving portion 53a (the state where the tank T is inserted to the lower end of the tank receiving portion 53a), the fluid leakage limiting valve Tb is pushed upward by a projection 53c, which is provided at the bottom of the tank receiving portion 53a, against the urging force of the spring (not shown). Thus, the outlet port Tc of the cap Ta is held in an open state.

Specifically, the tank T is detachably installed to the vehicle 1 (the housing 51). In the detached state of the tank T where the tank T is removed from the tank receiving portion 53a, the leakage of the washer fluid from the tank T is limited by the fluid leakage limiting valve Tb. In contrast, in the installed state of the tank T where the tank T is fully installed to the tank receiving portion 53a, the washer fluid can flow out from the tank T. The washer fluid, which flows out of the tank T in the installed state thereof, is filled in the fluid reservoir 52a, at which the electric pump P is installed, through the communication port 53b.

Furthermore, the electric pump P has a discharge port Pa, which projects outward from the fluid reservoir 52a on a side (the right side in FIG. 6A), which is opposite from the fluid suction port of the electric pump P. When the electric pump P is driven, the electric pump P suctions the washer fluid stored in the fluid reservoir 52a through the fluid suction port and discharges the suctioned washer fluid through the discharge port Pa. One end portion of the conduit 8 (see FIG. 5A) is connected to the discharge port Pa of the electric pump Pa.

The washer switch 9 is installed to the washer manipulation lever that is placed at the corresponding location, which is adjacent to the driver's seat, and the driver of the vehicle manipulates the washer switch 9 to turn on, i.e., to drive the electric pump P. Furthermore, a trunk door opening/closing sensing switch 55 is installed in the vehicle. The trunk door opening/closing sensing switch 55 can sense whether the trunk door 44 is opened, i.e., is in an open state. The open state of the trunk door 44 includes a full open state of the trunk door 44 and a semi-open state of the trunk door 44.

Also, a control circuit unit 16 is installed in the vehicle. The control circuit unit 16 serves as a discharge limiting device (also referred to as a discharge limiting means) and a washing control device, which determine whether the electric pump P needs to be driven. The control circuit unit 16 drives the electric pump P upon satisfaction of all of the following four conditions (prerequisite conditions), i.e., an ignition switch (ignition key) of the vehicle 1 being turned on (i.e., being in an ON state), the shift lever 3 being in the reverse position (the position for placing the vehicle 1 into the backwardly movable state, i.e., the reverse drive mode), the trunk door 44 being in a closed state, and the washer switch 9 being turned on (i.e., being in an ON state).

Specifically, as shown in FIG. 5B, the control circuit unit 16 includes a NAND circuit 61 and a transistor Tr of a pnp type (also referred to as a pnp transistor). Specifically, a fuse F1, the washer switch 9 and a resistor 62 are connected one after another in series between an ignition power source line Ig and a ground (earth). The ignition power source line Ig serves as a high potential power source (connected to a battery of the vehicle) in an ON state of the ignition switch (ignition key) of the vehicle 1. Furthermore, a fuse F2, a reverse drive sensing switch 63, and the back lamp BL are connected one after another in series between the ignition power source line Ig and the ground. The reverse drive sensing switch 63 is turned on when the shift lever 3 is placed in the reverse position. Also, a fuse F3, a trunk lamp 64 (not shown in FIG. 5A) and the trunk door opening/closing sensing switch 55 are connected one after another in series between a power source line B and the ground. The power source line B is connected to the battery. The trunk lamp 64 is installed in the luggage room 45. The trunk door opening/closing sensing switch 55 is placed in the ON state when the trunk door 44 is closed. Furthermore, a fuse F4, the transistor Tr and the electric pump P (the pump motor) are connected one after another in series between the ignition power source line Ig and the ground.

Furthermore, three nodes, i.e., a node N6, a node N7 and a node N8 are connected to three input terminals, respectively, of the NAND circuit 61. The node N6 is placed between the washer switch 9 and the resistor 62. The node N7 is placed between the reverse drive sensing switch 63 and the back lamp BL. The node N8 is placed between the trunk lamp 64 and the trunk door opening/closing sensing switch 55. An output terminal of the NAND circuit 61 is connected to a base of the transistor Tr.

Next, an operation of the washer system of the fourth embodiment, which is constructed in the above described manner, will be described. For instance, when the shift lever 3 is in the other position (the non-reverse position), which is other than the reverse position, in the ON state of the ignition switch (ignition key) of the vehicle 1, the reverse drive sensing switch 63 is turned off (i.e., placed in an OFF state). Therefore, the back lamp BL is turned off. In this state, an L-level signal is inputted from the node N7 to the NAND circuit 61. Therefore, the L-level signal is not outputted from the NAND circuit 61. As a result, the transistor Ti is in the OFF state, and the electric pump P (the pump motor) is held in the stop state.

For instance, when the shift lever 3 is in the reverse position, the reverse drive sensing switch 63 is turned on (i.e., placed in an ON state). Therefore, the back lamp BL is turned on. In this state, when the trunk door 44 is in the closed state, the trunk door opening/closing sensing switch 55 is turned on (i.e., placed in an ON state). Therefore, in such a case, when the washer switch 9 is turned on by the driver, the electric pump P (the pump motor) is driven. That is, the H-level signal is supplied from all of the nodes N6, N7, N8 to the NAND circuit 61 when the washer switch 9 is turned on in the state where the reverse drive sensing switch 63 is turned on, and the trunk door opening/closing sensing switch 55 is turned on. Therefore, the L-level signal is outputted from the NAND circuit 61. Thereby, the transistor Tr is placed in the ON state, and the electric pump P (the pump motor) is driven. Thus, the washer fluid, which is stored in the tank T, is pumped by the electric pump P to the rear camera washer nozzle 7 through the conduit 8 and is discharged, i.e., is sprayed to the lens side of the rear camera 6 from the washer fluid discharge opening of the rear camera washer nozzle 7. In this way, the rear camera 6 is washed. At this time, since the trunk door 44 is in the closed state, intrusion of the washer fluid into the interior compartment (the luggage room 5 in the inside of the trunk door 44) of the vehicle 1 is limited.

Furthermore, the L-level signal is not outputted from the NAND circuit 61 as long as the trunk door opening/closing sensing switch 55 is in the OFF state even when the washer switch 9 is turned on in the state where the reverse drive sensing switch 63 is turned on. Therefore, in such a case, the electric pump P (the pump motor) is held in the stop state. That is, when the trunk door 44 is in the open state, the discharging (spraying) of the washer fluid from the rear camera washer nozzle 7 is stopped.

Furthermore, for instance, at the time of refilling the washer fluid in the tank T through the opening Te of the tank T, the trunk door 44 is opened, and the tank T is detached (pulled) from the tank receiving portion 53a. Then, the cap Ta is detached from the opening Te of the tank T, and the washer fluid is filled in the tank T through the opening Te.

Next, advantages of the fourth embodiment will be described.

(1) The tank T is installed in the luggage room 45 at the rear side of the vehicle 1. Therefore, in comparison to the case where the tank T is installed at the front side (the engine room) of the vehicle, a distance from the tank T to the rear camera washer nozzle 7 can be shortened, and thereby a length of the conduit 8 can be shortened. In this way, even in a cold winter, particularly, at a cold weather region, a loss of the heat from the washer fluid at the time of flowing from the tank T (the electric pump P) to the rear camera washer nozzle 7 can be reduced or minimized. Thereby, it is possible to limit an increase in the viscosity of the washer fluid. As a result, the fluidity of the washer fluid at the lens side of the rear camera 6 can be maintained to enable smooth falling of the washer fluid from the lens side of the rear camera 6. Thus, it is possible to limit a distortion of the captured image (the rear view) caused by the presence of residue droplets of the washer fluid on the lens side of the rear camera 6. That is, the clear image, which has the minimum distortion, can be captured through the rear camera 6, and the lens side of the rear camera 6 can be appropriately washed.

In a case of a washer system for washing a rear window glass of the vehicle, even when the temperature of the washer fluid is reduced to cause an increase in the viscosity of the washer fluid and thereby to result in presence of the residue droplets on the rear window glass, it will not result in a significant trouble since such residual droplets can be wiped with a wiper after the spraying of the washer fluid. Therefore, in such a case, the advantage of placing the tank T in the luggage room 45 at the rear side of the vehicle 1 is small. In contrast, in the case of the washer system for washing the rear camera 6, the washer fluid is merely sprayed to the lens side of the rear camera 6 to wash the lens side of the rear camera 6 without using the wiper. Therefore, the advantage of placing the tank T in the luggage room 45 at the rear side of the vehicle 1 for the purpose of limiting the increase in the viscosity of the washer fluid to be sprayed is large, so that the significant advantage can be achieved.

Furthermore, the tank T is placed in the luggage room 45 (the inside of the trunk door 44) at the rear side of the vehicle 1. Therefore, the decreasing of the temperature of the washer fluid in the tank T can be more advantageously limited in comparison to the case where the tank T is exposed to the outside of the vehicle. Furthermore, it is not required to select the material of the tank T in view of the weather-resistance, which is required in the case where the tank T is exposed to the outside of the vehicle. Therefore, the costs can be reduced or minimized.

(2) The tank T is detachably installed to the vehicle 1. Therefore, the tank T can be carried by the user, and thereby the refilling of the washer fluid into the tank T can be eased.

(3) The electric pump P is fixed to the vehicle 1 (the housing 51), and the tank T is detachable from the vehicle 1 without accompanying the electric pump P. Therefore, in comparison to a case where the electric pump is fixed to the tank to detachably install the tank to the vehicle together with the electric pump, the carrying of the tank T is eased, and the refilling of the washer fluid to the tank T is eased.

(4) In the open state of the trunk door 44, the control circuit unit 16 (the discharge limiting device, which is also referred to as the discharge limiting means) limits the discharging, i.e., the spraying of the washer fluid from the rear camera washer nozzle 7. Therefore, it is possible to limit the intrusion of the washer fluid into the interior compartment (the luggage room 45 located at the inside of the trunk door 44).

(5) In the open state of the trunk door 44, the control circuit unit 16 places the electric pump P in the stop state. Therefore, the discharging of the washer fluid from the rear camera washer nozzle 7 is prevented. In this way, the spraying of the washer fluid can be prevented with the simple structure. Specifically, for instance, in a case where a valve drive device, which serves as a discharge limiting device (a discharge limiting means), is provided to enable and disable communication of the fluid passage between the electric pump P and the washer fluid discharge opening of the rear camera washer nozzle 7, a size of the washer system may be disadvantageously increased by the valve drive device, and an electric power may be wasted to drive the electric pump P. Also, in such a case, a pressure of the flow passage may be increased, and thereby a countermeasure may be required to counteract with the pressure increase. In contrast, according to the present embodiment, the above disadvantages can be limited, and the discharging of the washer fluid from the rear camera washer nozzle 7 can be appropriately prevented with the simple structure.

(6) Since it is only required to place the tank T in the luggage room (interior compartment) 45 of the vehicle to limit the loss of the heat from the washer fluid during, for instance, the cold winter, the washer system of the fourth embodiment can be easily added to the preexisting models of vehicles (e.g., the sedan automobile), which do not have the rear wiper (rear washer), at the minimum costs.

(7) The cap Ta can limit the outlet of the washer fluid from the tank T at the time of installing the tank T to the housing 51 (see the state of FIG. 6B). Also, due to the provision of the fluid leakage limiting valve Tb, the outlet port (opening) Tc of the cap Ta can be placed in the open state upon the installation of the tank T to the housing 51. These functions are implemented by adding the cap Ta of the present embodiment to a preexisting tank. Therefore, the costs can be reduced or minimized.

(8) The fluid reservoir 52a is provided in the housing 51, and the fluid suction port of the electric pump P is received in the fluid reservoir 52a. Therefore, the fluid suction port of the electric pump P is always immersed in the washer fluid in the fluid reservoir 52a. As a result, intrusion of the air (air bubbles) into the electric pump P through the fluid suction port of the electric pump P can be advantageously limited to limit mixing of the air into the washer fluid. In a case where the air is mixed into the washer fluid, the washer fluid, which is sprayed from the rear camera washer nozzle 7 onto the lens side of the rear camera 6, may possibly form washer fluid bubbles on the lens side of the rear camera 6. The presence of the washer fluid bubbles at the lens side of the rear camera 6 will interfere with the capturing of the clear view through the rear camera 6. However, the provision of the fluid reservoir 52a of the present embodiment can advantageously limit the intrusion of the air into the electric pump P, and thereby the formation of the washer fluid bubbles on the lens side of the rear camera 6 can be also limited to provide the clear image of the rear view through the rear camera 6.

### Fifth Embodiment

Now, a fifth embodiment of the present disclosure will be described. In the fourth embodiment, the electric pump P is driven upon satisfaction of the following four conditions, i.e., the ignition switch (the ignition key) of the vehicle 1 being turned on (i.e., in the ON state), the shift lever 3 being in the reverse position, the trunk door 44 being in the closed state, and the washer switch 9 being in the ON state. Alternatively, one or more of these conditions, which need to be satisfied to drive the electric pump P, may be replaced with another one or more conditions.

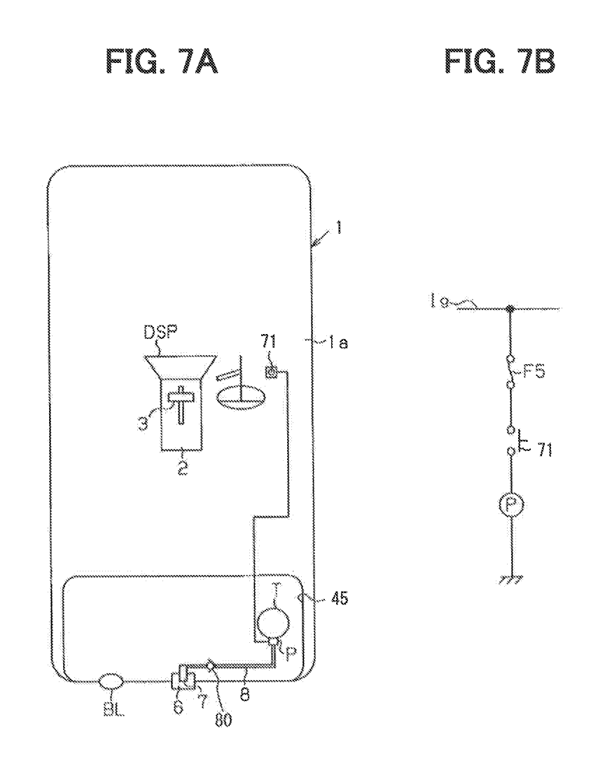

Specifically, in the fifth embodiment, as shown in FIG. 7A, a washer switch 71, through which the electric pump P can be driven (turned on) by the driver of the vehicle, is provided separately from the washer manipulation lever at a corresponding location, which is adjacent to the driver's seat. As shown in FIG. 7B, a fuse F5, the washer switch 71 and the electric pump P (the pump motor) are connected one after another in series between the ignition power source line Ig and the ground (the earth). Thus, when the washer switch 71 is turned on in the ON state of the ignition switch (the ignition key) of the vehicle 1, the electric pump P (the pump motor) is driven. Even with this modification, the advantages similar to those discussed in the sections (1) to (3) in the fourth embodiment can be achieved.

Now, further modification of the fourth embodiment will be described.

For example, the washer system of the fourth embodiment may be modified such that the electric pump P is driven (regardless of whether the trunk door 44 is opened) upon satisfaction of all of the following three conditions, i.e., the ignition switch (the ignition key) being in the ON state, the shift lever 3 being in the reverse position, and the washer switch 9 being in the ON state. Furthermore, for example, the washer system may be modified such that the electric pump P is driven (without a need for the washer switch 9) upon satisfaction of all of the following two conditions, i.e., the ignition switch (the ignition key) of the vehicle being in the ON state, and the shift lever 3 being in the reverse position.

Furthermore, for example, the washer switch 9, 71 discussed in the above embodiments and the modifications thereof may be changed to a touch panel switch, which is displayed on the display device DSP.

In the fourth embodiment, the tank T is detachably installed to the vehicle 1. However, the present disclosure is not limited to such a configuration. That is, the tank T may be non-detachably fixed to the vehicle 1 (i.e., the tank T being not detachable from the vehicle 1 unless removing, for example, bolts, which fix the tank T to the vehicle body 1a).

In the fourth embodiment, the electric pump P is fixed to the vehicle 1 (the housing 51), and the tank T is detachable relative to the vehicle 1 without accompanying the electric pump P. However, the present disclosure is not limited to this. For example, the electric pump may be fixed to the tank such that the tank is detachable together with the electric pump relative to the vehicle 1.

In the fourth embodiment, when the trunk door 44 is in the open state, the control circuit unit 16 stops the electric pump P to stop the spraying of the washer fluid from the rear camera washer nozzle 7. Alternatively, the discharge limiting device (the control circuit unit 16), which is also referred to as the discharge limiting means and limits (stops) the spraying of the washer fluid from the nozzle (the rear camera washer nozzle 7), may be changed to any other suitable arrangement. For example, the valve drive device, which enables or disables the communication of the fluid passage between the electric pump P and the washer fluid discharge opening of the rear camera washer nozzle 7, may be provided as the discharge limiting device (the discharge limiting means).

The circuit construction of the control circuit unit 16 is not limited to the one discussed in the fourth embodiment. That is, the control circuit unit 16 may be modified to any other circuit structure that has similar functions, which are similar to the functions of the control circuit unit 16 of the fourth embodiment.

In the fourth embodiment, the vehicle 1 is the sedan automobile (also referred to as the saloon automobile). However, the vehicle 1 is not limited to such a vehicle and may be changed to any other suitable automobile. For example, the vehicle 1 may be changed to a hatchback automobile or a one-box automobile (a van or a minivan). Furthermore, the trunk door 44, which serves as the back door of the vehicle, may be changed to a door of a corresponding type of automobile (e.g., a back door of a hatch back automobile). Furthermore, in the above embodiment, the tank T is the tank that stores the washer fluid for washing the rear camera 6. However, the present disclosure is not limited to this. For example, in a case of a vehicle, which has a rear wiper that wipes a rear window glass of the vehicle, the tank T may be a common tank, which stores washer fluid to be supplied to both of the rear camera 6 and the rear window glass. In such a case, there may be provided a switching valve device (e.g., a switching valve device similar to the switching valve device 22 of the second embodiment), which selectively supplies the washer fluid from the electric pump P to a corresponding one of a plurality of nozzles (e.g., the rear camera washer nozzle 7 and a rear window glass washer nozzle).

Additional advantages and modifications will readily occur to those skilled in the art. The present disclosure in its broader terms is therefore not limited to the specific details, representative apparatus, and illustrative examples shown and described. For instance, any one or more of the components of the washer system of any one or more of the first to fifth embodiments and modifications thereof may be combined with any one or more of the components of the washer system of another one or more of the first to fifth embodiments and modifications thereof within the principle of the present disclosure.

What is claimed is:

1. A washer system for a vehicle, comprising:
a tank that stores washer fluid;
an electric pump that pumps the washer fluid out of the tank;
a nozzle, which discharges the washer fluid to a washing subject installed in the vehicle upon receiving the washer fluid from the electric pump, wherein the washing subject is installed to an openable and closable body of the vehicle or an adjacent portion of a body of the vehicle, which is adjacent to the openable and closable body; and
a discharge limiting device that limits discharging of the washer fluid from the nozzle when the openable and closable body is in an open state.

2. The washer system according to claim 1, wherein the discharge limiting device is a washing control device, which limits the discharging of the washer fluid from the nozzle by stopping the electric pump.

3. The washer system according to claim 1, wherein:
the washing subject is one of a plurality of washing subjects installed in the vehicle;
the nozzle is one of a plurality of nozzles of the washer system, each of which discharges the washer fluid to a corresponding one of the plurality of washing subjects upon receiving the washer fluid from the electric pump; and
the washer system further comprises a switching device that selectively supplies the washer fluid received from the electric pump to a selected one of the plurality of nozzles.

4. The washer system according to claim 1, wherein:
the openable and closable body is a back door of the vehicle;
the washing subject is a rear camera that is installed to the back door or the adjacent portion of the body of the vehicle, which is adjacent to the back door;
the nozzle is a rear camera washer nozzle, which discharges the washer fluid to a lens side of the rear camera upon receiving the washer fluid from the electric pump; and
the discharge limiting device limits the discharging of the washer fluid from the rear camera washer nozzle when the back door is in the open state.

5. The washer system according to claim 1, wherein:
the openable and closable body is a back door of the vehicle;
the washing subject is a rear window glass, which is installed to the back door;
the nozzle is a rear window glass washer nozzle, which discharges the washer fluid to the rear window glass upon receiving the washer fluid from the electric pump; and
the discharge limiting device limits the discharging of the washer fluid from the rear window glass washer nozzle when the back door is in the open state.

6. The washer system according to claim 1, wherein:
the openable and closable body is a side window glass of the vehicle;
the washing subject is a side camera that is installed to the adjacent portion of the body of the vehicle, which is adjacent to the side window glass;
the nozzle is a side camera washer nozzle, which discharges the washer fluid to a lens side of the side camera upon receiving the washer fluid from the electric pump; and
the discharge limiting device limits the discharging of the washer fluid from the side camera washer nozzle when the side window glass is in the open state.

7. The washer system according to claim 1, wherein:
the openable and closable body is a side door of the vehicle;
the washing subject is a side camera that is installed to the side door or the adjacent portion of the body of the vehicle, which is adjacent to the side door;
the nozzle is a side camera washer nozzle, which discharges the washer fluid to a lens side of the side camera upon receiving the washer fluid from the electric pump; and
the discharge limiting device limits the discharging of the washer fluid from the side camera washer nozzle when the side door is in the open state.

8. The washer system according to claim 4, wherein:
the vehicle includes a luggage room that is placed at a rear side of the vehicle and is openable and closable with the back door;
the tank and the electric pump are installed in the luggage room; and
the electric pump and the rear camera washer nozzle are connected with each other through at least one conduit.

9. The washer system according to claim 8, wherein the tank is detachably installed to the body of the vehicle.

10. The washer system according to claim 9, wherein:
the electric pump is securely installed to the body of the vehicle; and
the tank is detachable from the body of the vehicle without accompanying the electric pump.

11. A washer system for a vehicle, comprising:
a tank that stores washer fluid and is installed in a luggage room of the vehicle;
an electric pump that pumps the washer fluid out of the tank;
a rear camera washer nozzle, which discharges the washer fluid to a lens side of a rear camera upon receiving the washer fluid from the electric pump, wherein the rear camera is installed to a rear side of the vehicle; and
at least one conduit, which connects between the electric pump and the rear camera washer nozzle.

12. The washer system according to claim 11, wherein the tank is detachably installed a body of the vehicle in the luggage room.

13. The washer system according to claim 12, wherein;
the electric pump is securely installed to the body of the vehicle; and
the tank is detachable from the body of the vehicle without accompanying the electric pump.

14. The washer system according to claim 13, further comprising a housing that is installed to the body of the vehicle, wherein:
the tank and the electric pump are installed to the housing;
the tank is detachable from the housing and
the tank supplies the washer fluid to the electric pump through the housing in an installed state of the tank where the tank is installed to the housing.

15. The washer system according to claim 14, wherein:
the tank has a cap, which is installed to an opening of the tank that is placed at a lower end of the tank in the installed state of the tank to the housing;
the cap is detachably installed to the opening of the tank to enable refill of the washer fluid into the tank through the opening of the tank upon detachment of the cap from the opening of the tank; and
the cap has a fluid leakage limiting valve, which opens an outlet port of the cap to enable outlet of the washer fluid from the tank through the outlet port when the tank is installed to the housing.

16. The washer system according to claim 14, wherein:
the housing has a fluid reservoir that is located on a lower side of the tank in the installed state of the tank to the housing; and
the electric pump is fixed to the housing and is communicated with the fluid reservoir.

17. The washer system according to claim 11, wherein:
the vehicle includes a back door, which is placed at a rear side of the vehicle and serves as an openable and closable body; and
the washer system further comprises a discharge limiting device that limits discharging of the washer fluid from the rear camera washer nozzle when the back door is in an open state.

18. The washer system according to claim 17, wherein the discharge limiting device is a washing control device, which limits the discharging of the washer fluid from the rear camera washer nozzle by stopping the electric pump.
